(19) United States
(12) Patent Application Publication
(10) Pub. No.: US 2002/0014302 A1
(43) Pub. Date: Feb. 7, 2002

(54) Method for incorporating rigid elements into the core of composite structural members in a pultrusion process

(75) Inventors: Jerome P. Fanucci, Lexington, MA (US); James J. Gorman, Boxborough, MA (US); Richard J. Balonis, Beaufort, SC (US); Christian Koppernaes, Beaufort, SC (US)

Correspondence Address: WEINGARTEN, SCHURGIN, GAGNEBIN & LEBOVICI LLP, TEN POST OFFICE SQUARE, BOSTON, MA, 02109, US

(73) Assignee: KAZAK COMPOSITES, INCORPORATED

(21) Appl. No.: 09/904,282

(22) Filed: Jul. 12, 2001

Related U.S. Application Data
(60) Provisional application No. 60/218,124, filed on Jul. 13, 2000.

(51) Int. Cl. B32B 5/00

(52) U.S. Cl. 156/179; 156/244.22

(57) ABSTRACT

A pultrusion method produces a composite structural member having rigid elements embedded therein. The structural member may be a sandwich structure in which one or more rigid, pre-rigidized, or rigidizable composite or non-composite structural elements are introduced at regular or irregular positions within core elements. The structural member may also be formed from layers of resin-matrix fiber fabric into a structural cross-section, such as an I-beam or T-beam, with a bundle of pre-pultruded rods located at the bends or the web-flange intersection points within layers.

### CROSS REFERENCE TO RELATED APPLICATIONS

This application claims the benefit under 35 U.S.C. §112(e) of U.S. Provisional Application No. 60/218,124, filed on Jul. 13, 2000, the disclosure of which is incorporated by reference herein.

### STATEMENT REGARDING FEDERALLY SPONSORED RESEARCH OR DEVELOPMENT

N/A

### BACKGROUND OF THE INVENTION

Sandwich structures consist of a thick, lightweight core surrounded by two higher density facings. The facings are often made from a different material than the core, with the facings glued to the core. This combination of materials and geometry is a weight-efficient construction, providing high stiffness and strength in proportion to weight compared to other arrangements of material. One typical implementation of a sandwich construction is a flat sandwich panel, composed of two thin sheets of a strong, stiff material such as steel, aluminum, plastic or fiber reinforced composite, attached, usually by some form of adhesive, to a much thicker core of lightweight material such as a foam or honeycomb.

Fiber-reinforced composite materials are a lightweight and strong combination of reinforcing fibers (fiber examples include glass, carbon, aramid, ceramic, etc.), in the form of individual threads or sheets of fabric-like broadgoods, held together by a matrix of “glue” such as a thermoset resin (examples include epoxy, polyester, vinyl ester, phenolic, bismaleimid, etc.), a thermoplastic (examples include nylon, polypropylene, PEEK, etc.), or various ceramics or metals.

Pultrusion is a cost effective manufacturing process for producing continuous runs of constant cross section structural members made from fiber reinforced composite material, particularly those made using thermoset and thermoplastic matrix materials. The details of a particular pultrusion process implementation vary depending on the specific materials being converted to useful structures and the shape of the structures being produced. In general, in a typical pultrusion process, a succession of processing operations is arranged one after the other in series and designed to function together as a single, continuously flowing stream, with each step of the process automatically feeding the next with a steady flow of material. For example, dry materials, in the form of individual tows of fibers (i.e., like thread on a spool) and/or fabrics of the same or different fiber on creels are continuously fed into a set of guides that form the materials into the general shape of the finished components. The materials are then fed into a station that completely wets the dry fiber materials with the matrix resin. The wet materials then enter the pultrusion die, in which the resin reacts or cures to a solid material. Curing may continue with additional heaters downstream of the die exit. A pulling mechanism is used to move the material continuously through the process at a steady pace. The production line may end with a cutting mechanism to cut the finished product to predetermined lengths.

One application of the pultrusion process is the production of sandwich panels made with foam core and thin composite skins. In one example of how a sandwich panel might be pultruded, sheets of core, often in the form of a homogeneous closed-cell foam that have been cut to the proper thickness and width are butted edge-to-edge so that no significant gap exists between the trailing edge of the first-to-be-introduced foam sheet and the leading edge of the next-introduced sheet of foam. These sheets are introduced between upper and lower skins of fiber fabric at any point before the entrance to the pultrusion die. The foam then moves through the process with the skins. The closed cell foam prevents resin impregnation into the cores. The finished part exits the die as two rigid cured composite face sheets laminated to the thicker, lightweight core.

### SUMMARY OF THE INVENTION

The present invention relates to a pultrusion method of producing a composite structural member having rigid elements embedded therein. In one embodiment, the method produces a sandwich structure composed of three types of components integrated into a single consolidated unit: (1) two thin face or outer skins, (2) a thicker core of a homogeneous, lightweight material, such as a closed cell foam, honeycomb, or balsa, to hold the inner and outer skins at a fixed separation distance, and (3) one or more rigid, pre-rigidized, or rigidizable composite or non-composite structural elements introduced at regular or irregular positions in the core.

The structural elements are generally smaller than the core elements and may take any desired cross-sectional shape, such as channel-shaped, I-shaped, H-shaped, T-shaped, Z-shaped, C-shaped, or box-shaped. The structural elements may be rigid elements, such as aluminum extrusions, or composite elements that have been pre-rigidized, such as pre-pultruded composite sections or elements. The structural elements may also be composite elements that are rigidized during the pultrusion process by impregnation and subsequent curing of resin. The structural elements may be sequenced with the core elements into the pultrusion process in advance of the pultrusion die in any desired configured, such as perpendicular or parallel to the pultrusion process direction.

After sequencing with the core elements, the face skins are fed onto the outwardly facing surfaces of the aligned elements to form a sandwich arrangement. The sandwich arrangement is passed through a wetting out tool which infiltrates any dry fiber components, that is, the face skins and, if necessary, the structural elements, with resin. The arrangement is then introduced into a heated pultrusion die for curing the resin. Any suitable pulling mechanism is provided to continuously pull the material through the process.

In another embodiment, the method produces a structural member with layers of fiber-reinforced fabric in the form of a structural cross-section, such as an I-beam or T-beam, with a bundle of pre-pultruded rods located at the bends or the web-flange intersection points within the layers. Accordingly, the present invention provides a method for embedding composite, resin-matrix elements within a composite structural member, so that the embedded structural elements become rigid structural elements within the composite structural members.

### DESCRIPTION OF THE DRAWINGS

The invention will be more fully understood from the following detailed description taken in conjunction with the accompanying drawings in which:

FIG. 1 is a schematic illustration of a pultrusion method for producing a sandwich panel structural member according to the present invention;

FIG. 2 is a schematic illustration of the pultrusion method of FIG. 1 with an exploded view of the sequencing of core elements and structural elements;

FIG. 3 is a partial cross-sectional view of a sandwich panel produced by the pultrusion method of FIG. 1;

FIG. 4 is a schematic illustration of examples of cross-sections of structural elements for use in the pultrusion method of the present invention;

FIG. 5 is a schematic illustration of a further embodiment of a pultrusion method of the present invention with an exploded view of the sequencing of wrapped core elements;

FIG. 6 is a schematic illustration of examples of wrapped core elements for use in the pultrusion method of the present invention;

FIG. 7 is a schematic illustration of a further embodiment of a pultrusion method of the present invention with an exploded view of the sequencing of core elements with through-the-thickness dry stitching;

FIG. 8 is a schematic illustration of a further embodiment of a pultrusion method of the present invention with structural elements fed longitudinally in horizontal or vertical planes between core elements; and

FIG. 9 is a partial cross-sectional view of a further embodiment of a structural member produced by the pultrusion method of the present invention;

### DETAILED DESCRIPTION OF THE INVENTION

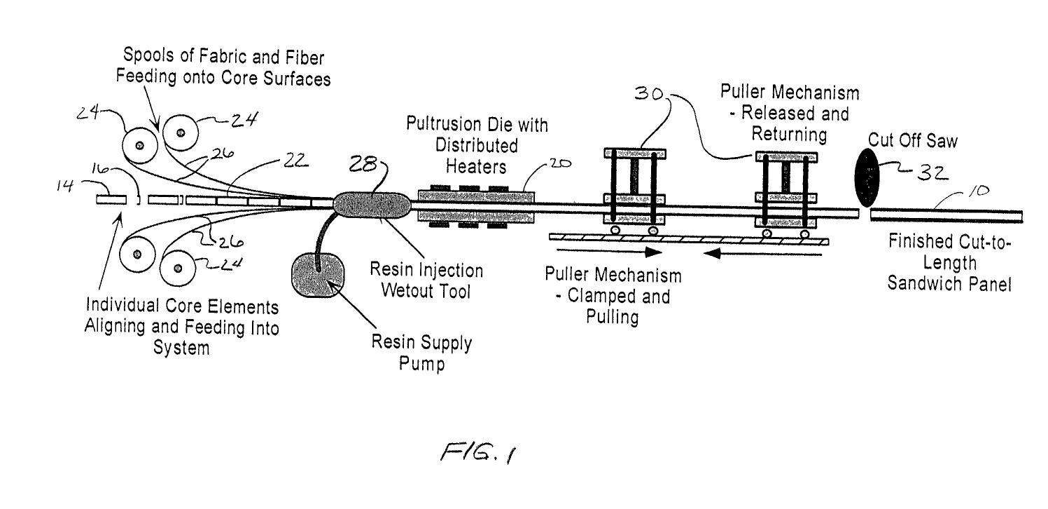

A first embodiment of the present invention is illustrated in FIGS. 1-3, which depict a method of making composite sandwich panels 10 (FIG. 3) using a pultrusion process. The resulting sandwich panel is composed of three distinct types of components integrated into a single consolidated unit: (1) two thin face or outer skins 12, (2) a thicker core 14 of a homogeneous, lightweight material, such as a closed cell foam, honeycomb, or balsa, to hold the inner and outer skins at a fixed separation distance, and (3) one or more rigid, pre-rigidized, or rigidizable composite or non-composite structural elements 16 introduced at regular or irregular positions in the core. The structural elements are added for a variety of reasons, including providing reinforcing, extra strength, and/or stiffness beyond that normally achievable using a homogeneous core, improving impact protection, forming hard points for mounting equipment, and providing hollow sections for running wires or for blowing heating or cooling air.

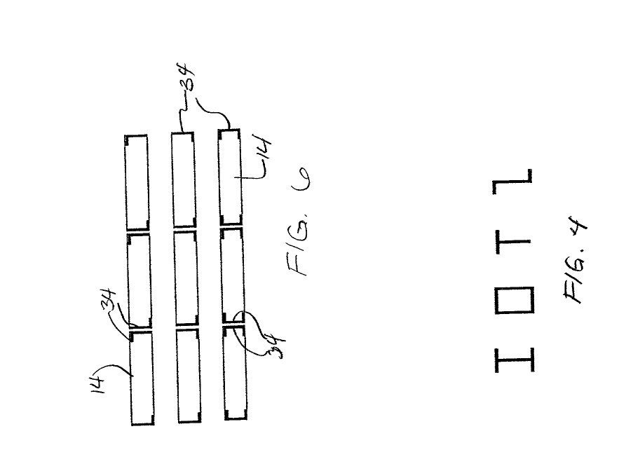

The structural elements are generally smaller than the core elements and may take any desired cross-sectional shape, such as channel-shaped, I-shaped, H-shaped, T-shaped, Z-shaped, C-shaped, or box-shaped. FIG. 4 illustrates examples of I-, box-, T-, and Z-shaped structural elements. The structural elements may be rigid elements, such as aluminum extrusions, or composite elements that have been pre-rigidized, such as pre-pultruded composite sections or elements. The structural elements may also be composite elements that are rigidized during the pultrusion process by impregnation and subsequent curing of resin.

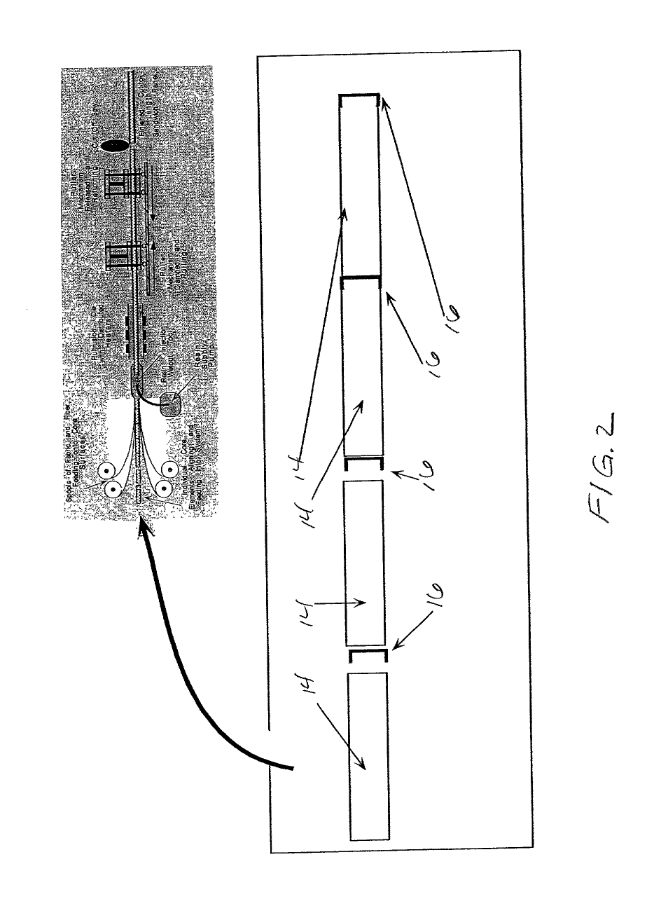

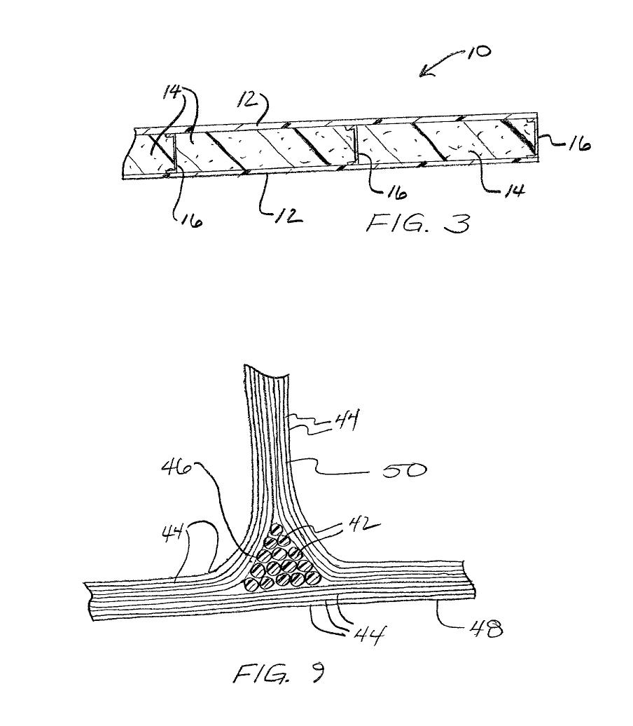

FIGS. 1 and 2 illustrate a schematic of a pultrusion processing system to make flat sandwich panels 10 containing composite skins and homogeneous foam core elements with the inclusion of an occasional rigid or pre-rigidized structural element inserted at appropriate locations between the opposed faces of adjacent core elements. The structural elements 16, channel-shaped in the illustrated embodiment, are inserted between adjacent core elements 14 at desired discrete locations prior to the entrance of the pultrusion die 20. The discrete structural elements and core elements are butted edge to edge as required by engineering requirements and fed into the pultrusion die as a continuous sheet 22. A bonding agent, such as the same resin used as the matrix material for the skins, may be applied onto the interfaces between the core and structural elements prior to the assembly of the sequenced core elements and structural elements. Alternatively, the sequenced elements may be bonded together with resin that flows into the interfaces between the structural elements and core elements during the resin wet out and infiltration step of the pultrusion process.

Fiber reinforcing materials in the form of individual tows of fiber and/or fabrics of the same or different fiber are positioned on creels 24 arranged to feed the dry fiber materials 26 continuously onto the surfaces of the sequenced core elements and structural elements and into the further pultrusion processing equipment. The fiber and cloth creels are usually followed by a set of guides (not shown) arranged to form the dry fiber into the general shape of the component being manufactured.

The guides feed the formed fiber collection into the resin wet out processing station 28, at which the previously dry fiber materials are fully wetted with the matrix resin. Any suitable type of resin wet out equipment may be provided, as would be known in the art. Typical examples include a wet bath (an open or closed vat of resin through which the fibers are pulled), a through-bath (a co-linear wet bath, usually holding a small quantity of resin), an external resin injection port (a close-fitting tool usually fed by a continuous supply of pumped resin), or a pumped injection port system integrated with the pultrusion die. During resin wet-out, the inserted structural elements 16 may also be impregnated with the same resin if desired. Typically, if the inserted elements are to be impregnated during this stage, a less viscous resin is used, the process is run at a slower speed and/or at a higher temperature, and/or vacuum or pressure resin assist may be used to ensure that the resin fully impregnates the inserted elements, as one of skill in the art may readily determine.

The resin-impregnated reinforcing fiber and matrix combination next enters the pultrusion die 20. This die is usually a multi-part steel tool having the mirror-polished cross section of the pultruded composite part machined through its length. The die is heated along its length. As the resin-impregnated assembly of fibers and/or fabrics is pulled through the heated tool, the resin reacts or cures, transforming from the liquid resin that enters the die to a solid matrix at the exit. In some cases, the curing of the resin continues after the part exits the die with additional inline heaters in the form of ovens, heat lamps, ultraviolet lights and other energy sources.

The material flow is maintained at a steady pace, typically between one-tenth to ten meters per minute, by some form of pulling mechanism 30 such as a tractor, roller or hand over hand mechanism. The pultrusion production line may end with an automated cut off saw 32 arranged to slice the finished composite product to predetermined lengths, if desired for the particular product. In some cases, cut pieces are placed in an off-line oven for additional curing. Many variations on the general pultrusion process described above may be practiced, depending on the desired finished product and available starting materials.

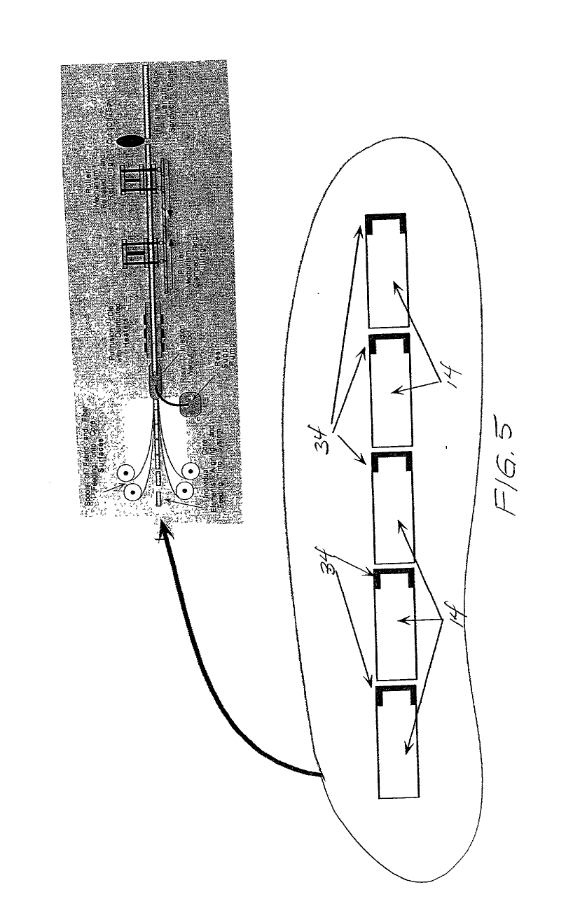

Referring to FIG. 5, a further embodiment is described in which cores 14 are prepared with their edges wrapped with a dry cloth 34 to form a composite structural member having occasional inserted fiber-reinforced C-stiffeners or I-stiffeners surrounded by homogeneous core. The cores are homogeneous lightweight pieces, such as foam or honeycomb, as described above. The cloth wrapping may cover one or more of the mating faces of the individual core elements. In other cases, the cloth wrapping material may also cover some of the top and/or bottom faces of the core element as well. Further examples of various wrapped configurations are illustrated in FIG. 6. Core wrapping can occur using continuous in-line equipment or alternatively may be prepared off-line in a secondary operation in preparation for the pultrusion process. Wrapped cores are then sequenced into the pultrusion stream as described above. Resin from any selected in-line wet out scheme flows or can be made to flow with additional processing equipment, such as vacuum or pressure assist, into the cloth inter-core reinforcing sheets. It is also possible to pre-wet the cloth materials on each core piece off-line by rolling resin onto cloth sheets or otherwise applying resin to appropriate areas of the cloth wrapping. When sequenced into the pultrusion stream, the cloth layers cure along with the upper and lower face skins, either inside the pultrusion die or later in the process. The resulting product forms solid composite reinforcing structural elements between and around the core elements.

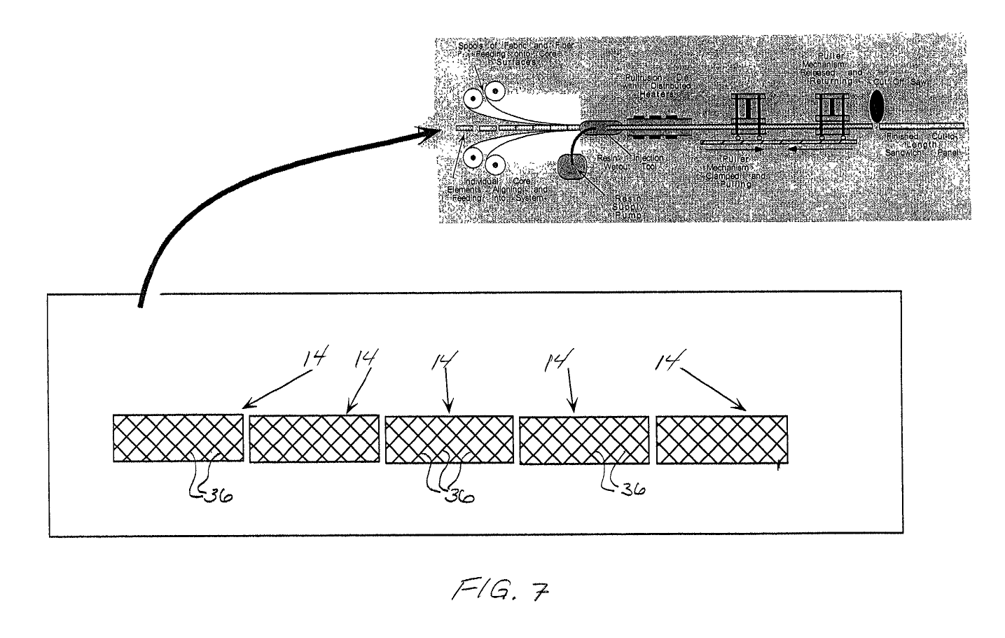

Referring to FIG. 7, a further embodiment is provided in which a continuous sequence of originally homogeneous lightweight foam cores 14, modified by the addition of occasional through-the-thickness stitching 36 of dry fiber at various angles and spacing, is fed into the pultrusion die along with the surfacing skins. The through-the-thickness stitching can be added to the core continuously by the inclusion of a sewing-type of machinery in-line and prior to the other pultrusion process equipment previously described, or alternatively pre-stitched unimpregnated cores can be made off-line and inserted into the pultrusion stream panel by panel. Dry-stitched core panels are available from WebCore Technologies, Inc. (See also U.S. Pat. Nos. 5,462,623, 5,589,243 and 5,834,082.) The stitching in the pre-stitched fiber cores may be pre-wet by soaking the cores in a bath of resin prior to feeding them sequentially into the pultrusion die. Alternatively or additionally, pressure and/or vacuum may be used to assist the resin flow into the through-the-thickness stitching fibers. Another approach is to wet the through-the-thickness stitching fibers of the core with resin using an in-line wet-out tool (a through bath, continuous in-line resin injection system, or the like). Another possibility is to conduct resin wet out in the pultrusion die itself, forcing resin through the reinforcing fiber layers on the surface of the core and down into the through-the-thickness fibers stitched through the core. In all of these implementations, heat from the pultrusion die, and/or possibly an in-line oven or off-line post curing oven then advances the curing of the resin in the skins and stitching fibers.

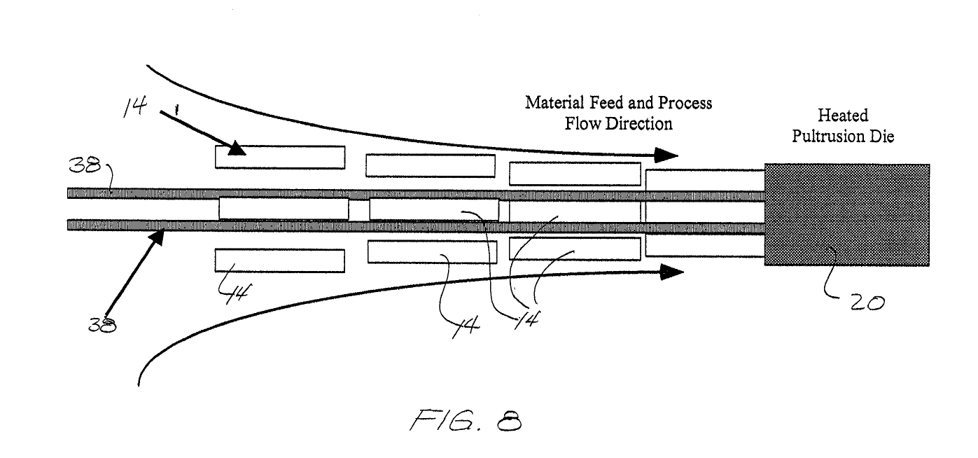

The structural elements in the embodiments above are perpendicular to the pultrusion direction. The structural elements can also be inserted parallel to the pultrusion direction to provide lengthwise core inserts. For example, referring to FIG. 8, blocks of core elements 14 are aligned for introduction into the pultrusion die. Long discrete lengths or continuously spooled or pre-pultruded or otherwise prepared structural elements 38 are fed in between the core elements, either in horizontal planes or in vertical planes, as desired. Some possible cross-sectional shapes of the lengthwise reinforcement elements are a hollow box, standard structural shapes such as I, T, C, H, or Z, or rods of circular or other cross-section. (See FIG. 4 for some examples.)

In a further embodiment, illustrated in FIG. 9, pre-pultruded rods 42 are assembled into a suitable shape, such as a triangle, and fed between layers of fiber fabric 44 at points 46 where the fabric is bent to form a particular structural shape. For example, multiple layers of fiber reinforcing fabric are shaped into a structure having a flange 48 and a web 50. The layers of the web fabric are separated and bent to form the intersection with the flange, which tends to form a generally triangular-shaped gap at the intersection. In prior art structures, care must be taken to prevent formation of this gap. As illustrated in FIG. 9, according to the present invention, the rods in a triangular bundle are introduced into the intersection between the flange and web before introduction to the pultrusion die, facilitating the manufacture of this structure and strengthening the finished structural member.

Structural elements can also be provided at selected locations to provide localized hard points inside the panels by inserting blocks of different types, weights, and/or strengths of core or other materials. For example, for a door panel, a small region of higher density material can be implanted at the location where a doorknob will be attached.

In the present invention, the lightweight foam or honeycomb core material used in processing the sandwich structures can be left inside the finished product. Alternatively, the lightweight core material can be removed by mechanical or chemical means, leaving only a now-rigid structure of solid fiber reinforced composite struts and/or thin vertical webs. Examples of the core-rigidizing elements include C- or I-section beam-like elements, or a distribution of many thin composite struts resulting from rigidization of the through-the-thickness perpendicular or angled stitching.

The above examples are presented as representative examples of a few of the possible processing techniques that can be used for the pultrusion of structures with rigid-element-reinforced cores and are not intended to present all possible processing variations covered by the disclosed methods. The invention is not to be limited by what has been particularly shown and described, except as indicated by the appended claims.

What is claimed is:

1. A pultrusion method of producing a composite structural sandwich member having a rigid structural element embedded therein, the method comprising the steps of:
providing at least one structural element comprising a rigid, pre-rigidized, or rigidizable element;
aligning a plurality of core elements in a process direction with the structural element disposed between opposed faces of at least two adjacent core elements;
feeding upper and lower fiber face skins onto outwardly facing surfaces of the aligned plurality of core elements to form a sandwich arrangement; and
pulling the sandwich arrangement through a pultrusion process comprising:
wetting out the sandwich arrangement with resin, and
introducing the sandwich arrangement into a heated pultrusion die to cure the resin.

2. The pultrusion method of claim 1, wherein in the step of providing the structural element, the structural element is formed from a fabric, and in the wetting out step, resin is further impregnated into the structural element.

3. The pultrusion method of claim 1, wherein in the step of providing the structural element, the structural element comprises a pre-pultruded element.

4. The pultrusion method of claim 1, wherein in the step of providing the structural element, the structural element comprises a pre-impregnated fiber-reinforced element.

5. The pultrusion method of claim 1, wherein in the step of providing the structural element, the structural element is channel-shaped, I-shaped, H-shaped, T-shaped, Z-shaped, C-shaped, or box-shaped in cross-section.

6. The pultrusion method of claim 1, wherein in the step of providing the structural element, the structural element is hollow in cross-section.

7. The pultrusion method of claim 1, wherein the structural element comprises a fabric material, and in the aligning step, the fabric material is wrapped over a portion of at least one core element.

8. The pultrusion method of claim 1, wherein the structural element is disposed between the adjacent core elements in a plane perpendicular to the direction of travel in the pultrusion process.

9. The pultrusion method of claim 1, wherein the structural element is disposed horizontally between the adjacent core elements in a plane parallel to the direction of travel in the pultrusion process.

10. The pultrusion method of claim 1, wherein the structural element is disposed vertically between the adjacent core elements in a plane parallel to the direction of travel in the pultrusion process.

11. The pultrusion method of claim 1, wherein the structural element is disposed in a predetermined location to provide a hard point within the sandwich arrangement.

12. The pultrusion method of claim 1, wherein the structural element is disposed between opposed faces of a plurality of adjacent core elements.

13. The pultrusion method of claim 1, further comprising disposing a plurality of structural elements between opposed faces of a corresponding plurality of two adjacent core elements;

14. The pultrusion method of claim 1, wherein the pultrusion process further comprises heating the sandwich arrangement downstream of the pultrusion die to further cure the resin.

15. The pultrusion method of claim 1, wherein in the wetting out step, resin is impregnated into the upper and lower fiber face skins.

16. The pultrusion method of claim 1, wherein in the aligning step, the core elements comprise a homogeneous material.

17. The pultrusion method of claim 1, wherein in the aligning step, the core elements are formed from a foam material or a balsa material.

18. The pultrusion method of claim 1, wherein in the aligning step, the core elements are formed of a closed cell or honeycomb material.

19. A method for embedding a composite, fiber-reinforced, resin-matrix structural element into a composite structural member in a pultrusion process, comprising:
providing a plurality of core elements, at least one of the core elements comprising a homogeneous material having reinforcing stitching through a thickness of the at least one core element;
aligning the plurality of core elements in a process direction;
feeding upper and lower fiber face skins onto outwardly facing surfaces of the aligned plurality of core elements to form a sandwich arrangement; and
pulling the sandwich arrangement through a pultrusion process comprising:
wetting out the upper and lower fiber face skins and the reinforcing stitching with resin, and
introducing the sandwich arrangement into a heated pultrusion die to cure the resin.

20. The method of claim 19, wherein in the providing step, the reinforcing stitching extends diagonally through the thickness of the at least core element.

21. The method of claim 19, wherein in the providing step, the reinforcing stitching extends perpendicularly through the thickness of the at least core element.

22. A method for embedding a composite, fiber-reinforced, resin-matrix structural element into a composite structural member in a pultrusion process, comprising:
arranging a plurality of pultruded rods into a bundle;
feeding a plurality of layers of a fiber reinforcing material over the pultruded rods;
forming the layers into a form of the composite structural member, the form having a least one bend in a portion of the layers, with the bundle of pultruded rods embedded within the layers at the bend; and
pulling the structural member through a pultrusion process comprising:
wetting out the plurality of layers with resin, and
introducing the structural member into a heated pultrusion die to cure the resin.

23. A composite structural member form by the method of claim 22.
